(19) United States
(12) Patent Application Publication
(10) Pub. No.: US 2026/0077401 A1
(43) Pub. Date: Mar. 19, 2026

(54) METHOD AND SYSTEM FOR GRIPPING AND MOVING OBJECTS

(71) Applicant: SALVAGNINI ITALIA S.P.A., Sarego (VI) (IT)

(72) Inventors: Bruno SAMBI, Sarego (VI) (IT); Piero Alberto SANTAGIULIANA, Sarego (VI) (IT); Manuel BRESSANELLO, Sarego (VI) (IT)

(21) Appl. No.: 19/107,309

(22) PCT Filed: Aug. 8, 2023
(86) PCT No.: PCT/IB2023/057984

§ 371 Date: Feb. 27, 2025

(30) Foreign Application Priority Data
Aug. 29, 2022 (IT) 102022000017751

(51) Int. Cl. B21D 43/10; B21D 43/02; B25J 9/16; B25J 19/02

(52) U.S. Cl. CPC B21D 43/10; B21D 43/025; B25J 9/1669; B25J 9/1697; B25J 19/022

(57) ABSTRACT

A method for gripping and moving worked pieces obtained by cutting and/or punching at least one sheet metal and arranged on a work surface includes positioning a gripping assembly at a piece to be picked up and at the same time positioning a sensor device by moving it along a first direction in a first position in which the sensor device is aligned with a projection of a peripheral edge of the piece along a second direction orthogonal to first direction, and grasping and lifting the piece at a defined height with respect to the work surface by the gripping assembly. The method also includes activating the sensor device and moving it to a second position to scan a settled portion of work surface that is below the lifted piece in order to detect a gap or a residual connection between lifted piece and the sheet metal.

The invention relates to gripping and moving methods and systems associated with automatic machines for cutting and/or punching metal sheets to pick up, remove and move the finished pieces from the sheet metal after cutting and/or punching. More precisely, the invention relates to a method for gripping and moving that allows to check the correct detachment of the finished pieces from the sheet metal after cutting and/or punching. The invention also relates to a system for gripping and moving the finished and cut pieces provided with a detection apparatus and associable with an automatic machine for cutting and/or punching sheet metal.

Systems for gripping and moving worked pieces/objects are known and used in machines for cutting and/or punching sheet metal that comprise detection apparatuses that use sensors capable of scanning the upper surface of a work surface of the machine, on which the sheet metal to be cut and/or punched and the pieces/objects obtained from the cutting/punching are positioned. More precisely, during an unloading step of the machine work surface at the end of the cutting and/or punching steps, while the finished pieces are gripped and removed, the detection apparatuses verify that the pieces, which are picked up and lifted by suitable gripping means of gripping and moving systems, are completely separated from the residual portion of the sheet metal (skeleton), thus preventing the gripping means from lifting and/or dragging the entire sheet with the pieces due to an incomplete cutting and/or punching.

In particular, the sensors of the detection apparatus, typically of the optical type, during this unloading step, scan the entire work surface to detect the presence or absence of obstacles, i.e. the absence of a gap or space of defined height (typically 20 mm) between the pieces lifted by the gripping means and the sheet metal, this indicating the lack of effective and complete detachment and separation of the pieces from the sheet metal.

The use of detection apparatuses comprising a rotating head emitting a laser beam capable of scanning the work surface in relatively fast time is known. However, since these apparatuses must be positioned at a certain distance from the work surface so as not to hinder the picking and moving of the pieces, the resolution they guarantee and which decreases with increasing distance, is generally low and sometimes lower than the thickness of pieces and sheet metal, thus not ensuring a correct identification of the detachment of the pieces.

It is also known to use photoelectric safety barriers that employ a plurality of LEDs that are linearly arranged and adapted to send a pulsed infrared light to a plurality of receivers in order to create a light curtain capable of intercepting the pieces not correctly detached. However, these systems also offer a low scanning resolution (10-15 mm).

Detection apparatuses are also used that comprise laser sensors capable of emitting a laser beam and receiving its reflection, said sensors being movable parallel to one side of the work surface so as to progressively scan the entire work surface. In order to reduce the time required for scanning, these apparatuses comprise a plurality of laser sensors spaced apart from one another and movable together. These scanning systems ensure a high resolution (2.5-3 mm), but still require a certain time (2-4 s) to scan the entire work surface.

Detection apparatuses are also known and used that utilize a vision system capable of detecting the geometry of pieces and sheet metal and in particular identifying the gap or distance between the piece and the sheet metal following picking and lifting. Vision systems, however, in addition to being quite expensive, are difficult and tough to set up and adjust.

It is an object of the present invention to improve the known methods and systems for gripping and moving that can be associated with automatic cutting and/or punching machines and are adapted to safely and reliably pick up and move the finished pieces from the sheet metal after cutting and/or punching.

Another object of the invention is to provide a method and a system for gripping and moving that allow checking in a very quick and at the same time precise and accurate manner the correct detachment of the finished pieces from the sheet metal after cutting and/or punching.

A further object is to provide a method and a system for gripping and moving that allow scanning with high resolution the work surface of the associated automatic sheet metal cutting and/or punching machine.

In a first aspect of the invention a method for gripping and moving according to claim 1 is provided.

In a second aspect of the invention a gripping and moving system according to claim 6 is provided.

The invention can be better understood and implemented with reference to the attached drawings which illustrate an exemplary and non-limiting embodiment thereof, wherein:

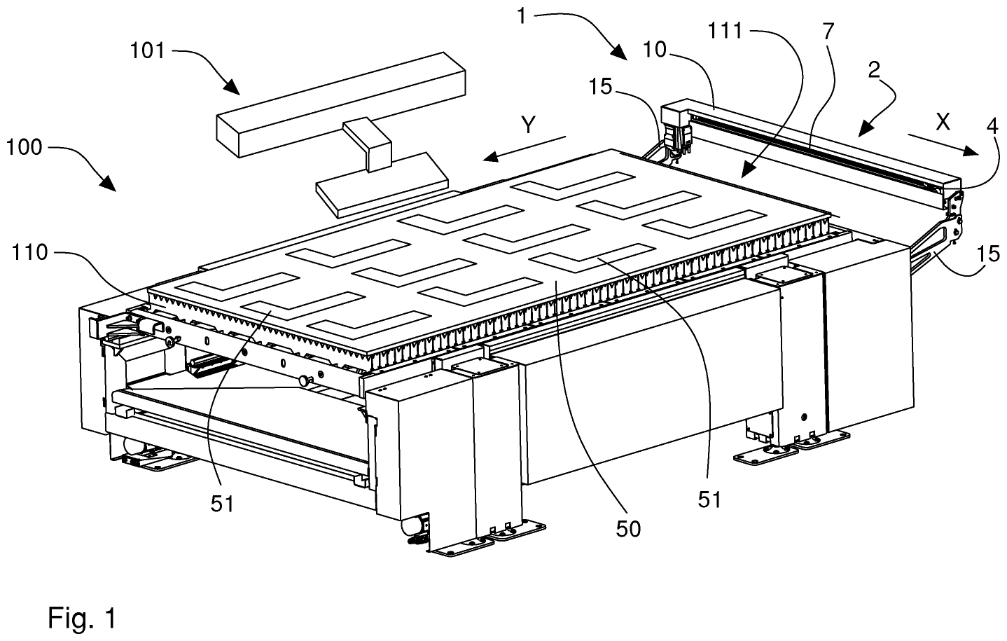

FIG. 1 is a perspective view of a gripping and moving system according to the invention associated with a work surface;

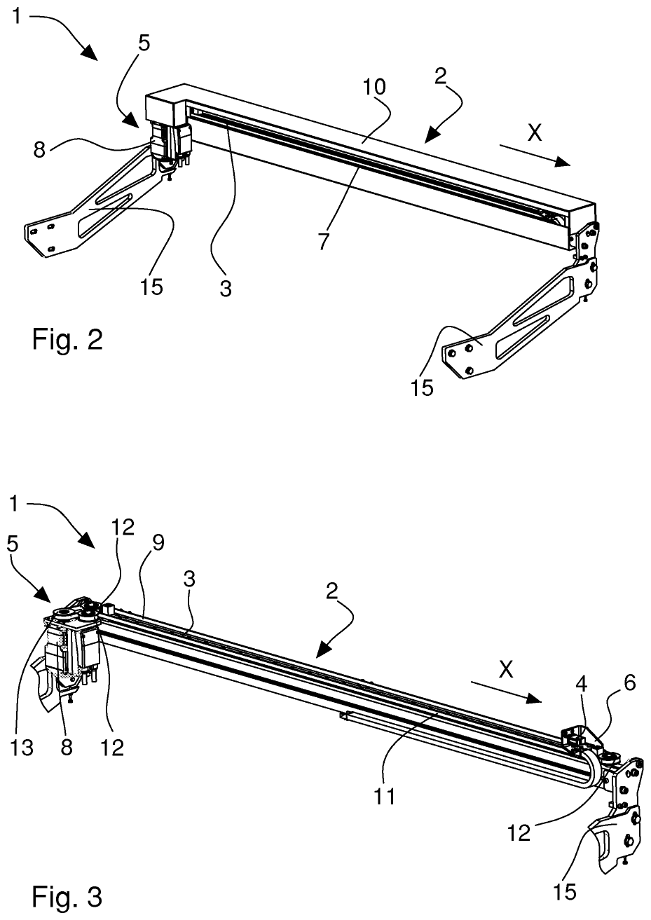

FIG. 2 is a perspective view of a detection apparatus of the gripping and moving system of FIG. 1;

FIG. 3 is a perspective view of the detection apparatus of FIG. 2 having a covering casing removed;

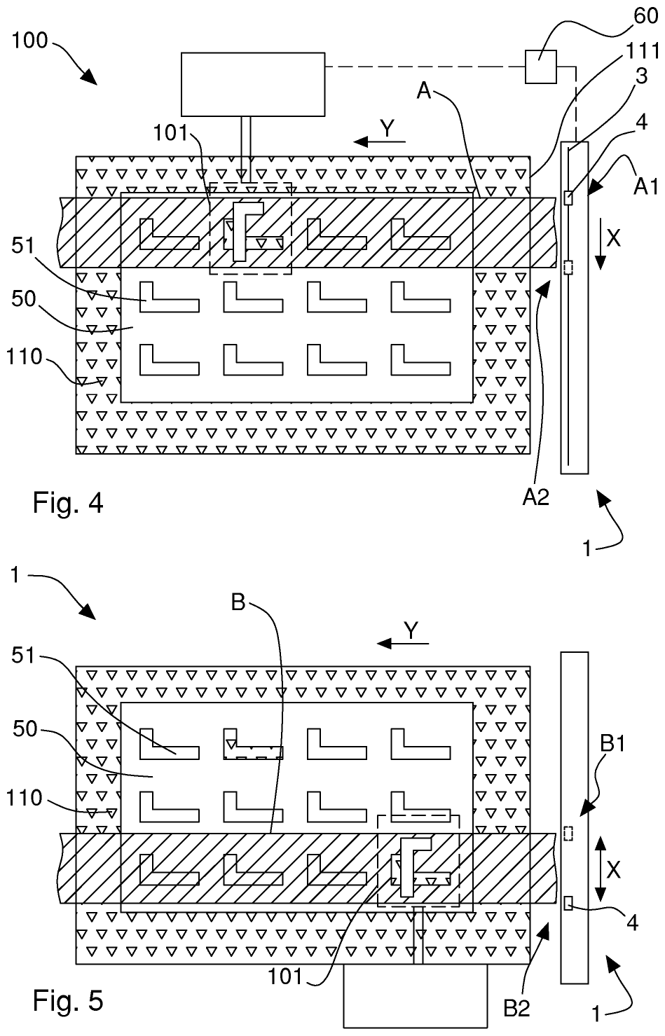

FIGS. 4 and 5 are schematic plan views of the gripping and moving system and the work surface of FIG. 1, respectively, during a first and a second step of picking up pieces.

With reference to FIGS. 1 to 5, the gripping and moving system 100 of the invention provided with a detection apparatus 1 is illustrated.

The gripping and moving system 100 can be associated with a work surface 110 that is adapted to support at least one sheet metal 50 to be machined and/or machined pieces 51. The work surface 110 is, for example, the work surface of an automatic machine for cutting and/or punching sheet metal 50 in order to produce finished machined pieces 51.

The detection apparatus 1, or apparatus 1, is fixed to a side 111 of the work surface 110. The apparatus 1 comprises a supporting element 2 elongated along a first direction X, in particular parallel to the side 111, and provided with linear guide means 3 for slidably supporting along the first direction X a sensor device 4 configured to detect a gap or a residual connection between the pieces 51 and the sheet metal 50. At the end of the machining (cutting and/or punching) of the sheet metal 50, it is in fact possible that the thus obtained machined pieces 51 are not completely separated from the residual portion of sheet metal 50 (skeleton), but are still connected at one or more points thereto. It is also possible that while moving the work surface some of the cut pieces detach and remain in an incorrect position.

The sensor device 4 comprises, for example, a laser scanner sensor, in particular an amplified photosensor, in particular a polarized retro-reflective amplified photosensor with reflector. In particular, the reflector or equivalent reflective element, of known type and not illustrated in the figures, arranged to reflect the laser beam emitted by the sensor, is attached to an opposite side of the work surface 110 facing the sensor itself.

The apparatus 1 is fixed to the side 111 of the work surface 110 so that the sensor device 4 faces the work surface 110 to detect the presence of a residual connection between the pieces 51 and the sheet 50.

The apparatus 1 further includes driving means 5 associated with the supporting element 2 and configured to position and move in a controlled manner the sensor device 4 along the first direction X. In particular, the driving means 5 are configured to position and then move the sensor device 4 so as to scan a settled portion A, B of the work surface 110. In particular, the portion A, B extends along a second direction Y substantially orthogonal to the first direction X. The apparatus 1 comprises a carriage 6 coupled to, and movable along, the guide means 3 and supporting the sensor device 4. The carriage 6 is driven along the guide means 3 by the driving means 5.

The guide means 3 comprise, for example, a linear guide or rail, of known type, to which the carriage 6 is connected and along which can slide.

The driving means 5 comprise, for example, a rotary electric motor 8, in particular a brushless electric motor, controllable in position and/or speed. More precisely, the rotary electric motor 8 is of a step-by-step motor, i.e. a synchronous direct current motor that allows an accurate control of the positioning of the sensor 4. The driving means 5 may alternatively comprise further types of electric motors, such as for example an inverter-controlled asynchronous motor.

The driving means 5 further include transmission means 9 that are driven by the rotary electric motor 8 and are connected to the sensor device 4 and adapted to move this linearly along the guide means 3. In particular, the transmission means 9 comprise at least one endless moving belt 11, in particular of the toothed type, wrapped around pulley means 12, 13. These pulley means 12, 13 are rotatably fixed to the supporting element 2 while the carriage 6 is connected to the moving belt 11.

The pulley means 12, 13 comprise a plurality of return pulleys 12 and a driving pulley 13 driven in rotation by the rotary electric motor 8. More precisely, the pulley means 12, 13 are positioned at the ends of the supporting element 2 and are mechanically interconnected by the moving belt 11.

The supporting element 2 comprises a covering casing 10 adapted to enclose at least the guide means 3 and the driving means 5 and provided with a longitudinal opening 7 that extends along and at the guide means 3 and that allows the sensor device 4 to scan externally to the supporting element 2.

The apparatus 1 further comprises connection brackets 15 for fixing opposite ends of the supporting element 2 to the work surface 110. The connection brackets 15 also allow a fine adjustment of the laser beam emitted by the sensor device 4 with respect to the work surface and the possible retro-reflective surface.

The gripping and moving system 100 comprises gripping means 101 configured to grip and pick up from the work surface 110 the machined pieces 51, obtained by cutting and/or punching the sheet metal 50.

The gripping and moving system 100 comprises a control unit 60 arranged to control the gripping means 101 and the detection apparatus 1 and to control the driving means 5 of detection apparatus 1 so as to position and move the sensor device 4 along a first direction so as to scan a settled portion A, B of the work surface 110 in which there is at least one piece 51 to be picked up and lifted up by the gripping means 101.

More precisely, the control unit 60 coordinates the movement of the gripping means 101 and the sensor device 4 in such a way as to reduce the waiting times in which the machine is inactive.

particular, the control unit 60 is configured to control the gripping means 101 and the detection apparatus to perform the following steps of the gripping and moving method of the invention.

The method according to the invention for gripping and moving machined pieces 51 obtained by cutting and/or punching at least one sheet metal 50 and arranged on a work surface 110 by means of a gripping and moving system 100 provided with a detection apparatus 1 comprises:
positioning gripping means 101 of the gripping and moving system 100 on at least one piece 51 to be picked up from the work surface 110 (step 1) and at the same time
positioning a sensor device 4 of the detection apparatus 1 by moving it along a first direction X in a first position A1, B1 in which the sensor device 4 is substantially aligned with a projection of a peripheral edge of the piece 51 along a second direction Y substantially orthogonal to the first direction X (step 2);
gripping and lifting the piece 51 by a defined height with respect to the work surface 110 by means of gripping means 101 (step 3);
activating the sensor device 4 and moving it to a second position A2, B2 so as to scan a settled portion A, B of the work surface 110 below the lifted piece 51 so as to detect a gap or a residual connection between the piece 51 and the sheet 50 (step 4).

The method also comprises stopping the lifting of the piece 51 if the sensor device 4 detects residual connection between the piece 51 and the sheet metal 50 (step 5) or alternatively further lifting and moving the piece 51 out of the work surface 110, if the sensor device 4 does not detect a residual connection between the lifted piece 51 and the sheet 50 (step 6). With particular reference to FIGS. 4 and 5, the settled portion A, B of the work surface 110 scanned by the sensor device 4 extends along the second direction Y and has a width along the first direction X equal to a distance between the first position A1, B1 and the second position A2, B2 and substantially equal to or greater than a maximum dimension of the piece 51 along the first direction X.

The method further comprises repeating steps 1 to 5 or steps 1-4 and 6 for each piece 51 to be picked up from work surface 110.

The method of the invention also comprises positioning the gripping means 101 at a settled plurality of machined pieces 51 to be picked up (step 1) from the work surface 110 and gripping and lifting said settled plurality of pieces (51), in this case the settled portion A, B of the work surface 110 scanned by the sensor device 4 being below the settled plurality of pieces 51 lifted by the gripping means 101.

In this case the sensor device 4 detects a possible residual connection between each lifted piece 51 and the sheet metal 50.

The operation of the gripping and moving system 100 of the invention that implements the above disclosed method for gripping and moving comprises in an initial step the positioning on the work surface 110 of a sheet metal 50 from which have been made, for example by means of a cutting and/or punching process of known type, a plurality of finished pieces 51 to be picked up and removed by gripping means 101.

Before their complete removal, the detection apparatus 1 must check that each piece 51 is actually separated from the skeleton of the sheet metal 50 so that the gripping means 101 do not lift also the sheet metal 50 together with the piece.

For this purpose, the control unit 60 of gripping system 1 controls and coordinates the movement of the gripping means 101 and of the sensor unit 4. More precisely, the control unit 60 controls the gripping means 101 to bring them closer to a settled piece 51 to be picked up from the work surface 110 and the driving means 5 so as to move the sensor device 4 along the guide means 3 in a first position A1 in which said sensor device 4 is substantially aligned with a projection of the peripheral edge of the piece 51 along the second direction Y substantially orthogonal to the first direction X (FIG. 4).

Sensor device 4 can be moved in the first position A1 also before moving the gripping means 101.

Subsequently, the gripping means 101 grip and lift the piece 51 of a defined and settled height. The piece 51 can be partially lifted and then rested on the work surface 110 for a plurality of times, typically to eliminate any minimal connection points between a peripheral edge of the piece 51 and the skeleton of the sheet metal 50.

At the end of this procedure, with the piece 51 lifted from the work surface 110 by a defined height (for example equal to 40 mm) the sensor device 4 is moved from the first position A1 to the second position A2 along the guide means 3 by the driving means 5 so as to scan the entire portion A of the work surface 110 below the piece 51.

If the sensor device 4 detects a residual connection between the partially lifted piece 51 and the sheet metal 50, i.e. the lack of a gap between piece and sheet, the picking up of the piece is stopped and the latter is repositioned on the work surface 110 because it is still connected to the skeleton of the sheet metal. More precisely, the piece 51 is positioned on the work surface 110 and then lifted again for a confirmation scanning.

On the contrary, if the sensor device 4 does not detect any obstacle or residual connection between piece and sheet, i.e. it detects a gap between the lifted piece 51 and the sheet 50, the picking up is not stopped and the piece 51 is further lifted and transported externally to the work surface 110.

In order to move the sensor device 4 along the guide means 3, the electric motor 8 of the movement means 5 is activated. More precisely, the electric motor 8 through the drive pulley 13 moves the moving belt 11 to which the carriage 6 is fixed, which supports the sensor device 4 and which can slide along the guide means 3, so as to position the sensor device 4 in the first position A1 and then in the second position A2 along the first direction X.

While the piece 51 is transferred and removed from the work surface 110, the sensor device 4 can be positioned by the driving means 5 in another first position B1 in which said sensor device 4 is substantially aligned along the second direction Y to the projection of a peripheral edge of another piece 51 to be picked up and removed (FIG. 5). It should be noted that the other piece 51 could also be in the same row as the piece 51 previously picked up at a different position along the second direction Y.

Once said other piece 51 to be picked up is gripped and lifted by the gripping means 101, the sensor device 4 can be moved by the driving means 5 to the other second position B2 so as to scan another portion B of the work surface 110 below the partially lifted piece 51.

This procedure may be repeated in succession for all pieces 51 to be picked up from the work surface 110.

In this way, advantageously, the time necessary to perform the control of the pieces 51 is considerably reduced since the time necessary to check that each piece 51 is correctly detached from the skeleton of the sheet metal is the time required by the sensor device 4 to scan the respective portion A, B of the work surface 110 corresponding to and below only the piece 51 and not the entire surface 110 as occurs in known detection systems. This time even in the case of pieces 51 of considerable size is a few tenths of a second, thanks also to the performance of the electric motor 8 and the transmission means 9 of driving means 5. In particular, driving means allow positioning the sensor device 4, i.e. the carriage 6, in a quick and at the same time precise and accurate manner along guide means 3, in the different first and second positions A, B that are determined based on the position along the first direction X of the different pieces 51 to be picked up.

It is also provided that the gripping means 10 are configured to pick up and lift at the same time a settled plurality of machined pieces 51 from the work surface 110. In this case, the settled portion A, B of the work surface 110 scanned by the sensor device 4 is portion below the settled plurality of pieces 51 hat are lifted by the gripping means 10 and the sensor device 4 detects a possible residual connection between each lifted piece 51 of the plurality and the sheet 50.

1-14. (canceled)

15. A method for gripping and moving worked pieces obtained by at least one between cutting and punching at least one sheet metal and arranged on a work surface by means of a gripping and moving system provided with a detection apparatus, comprising:
positioning a gripping assembly of said gripping and moving system on at least one piece to be picked up from said work surface (step 1) and at the same time
positioning a sensor device of said detection apparatus by moving it along a first direction in a first position in which said sensor device is substantially aligned with a projection of a peripheral edge of said piece along a second direction, which is substantially orthogonal to said first direction (step 2);
grasping and lifting said at least one piece at a defined height with respect to said work surface by means of said gripping assembly (step 3);
activating said sensor device and moving it to a second position so as to scan a settled portion of said work surface below said lifted piece in order to detect a gap or a residual connection between said lifted piece and said sheet metal (step 4).

16. The method according to claim 15, further comprising:
stopping said lifting said piece if said sensor device detects a residual connection between said lifted piece and said sheet (step 5); or
further lifting and moving said piece outside said work surface if said sensor device does not detect a residual connection between said lifted piece and said sheet (step 6).

17. The method according to claim 15, wherein said settled portion of the working plane scanned by said sensor device extends along said second direction and has a width along said first direction equal to a distance between said first position and said second position and substantially equal to, or longer than, a maximum dimension of said piece along said first direction.

18. The method according to claim 15, comprising repeating the steps 1 to 5 or the steps 1-4 and 6 for each piece to be picked up from said work surface.

19. The method according to claim 15, comprising positioning said gripping assembly at a plurality of worked pieces to be picked up (step 1) and grasping and lifting said plurality of worked pieces, said settled portion of said work surface being below said plurality of worked pieces lifted by said gripping assembly.

20. A gripping and moving system associable with a work surface suitable to support at least one between a sheet metal to be worked and worked pieces, comprising:
a gripping assembly for gripping and picking said worked pieces from said work surface;
a detection apparatus comprising:
a supporting element elongated along a first direction and provided with a linear guide assembly;
a sensor device configured to detect a residual connection between said pieces and said sheet and slidably supported by said guide assembly along said first direction;
a driving system associated with said supporting element and configured to position and move said sensor device in a controlled manner along said first direction;
a control unit configured to control said gripping assembly and said detection apparatus so as to execute the steps of the method according to claim 15.

21. The gripping and moving system according to claim 20, wherein said control unit is configured to control said driving system of said detection apparatus so as to position and move said sensor device along a first direction in order to scan a settled portion of the work surface in which there is at least one worked piece.

22. The gripping and moving system according to claim 20, wherein said detection apparatus comprises a carriage coupled with, and movable along, said guide assembly and supporting said sensor device, said carriage being driven along said guide assembly by said driving system.

23. The gripping and moving system according to claim 20, wherein said driving system comprises a rotary electric motor controllable in at least one between position and speed, and a transmission arrangement driven by said rotary electric motor and connected to, and capable to move linearly, said sensor device along said guide assembly.

24. The gripping and moving system according to claim 22, wherein said driving system comprises a rotary electric motor controllable in at least one between position and speed, and a transmission arrangement driven by said rotary electric motor and connected to, and capable to move linearly, said sensor device along said guide assembly, wherein said transmission arrangement comprises at least one moving belt which is wound around a pulley arrangement that is rotatably fixed to said supporting element, said carriage being connected to said moving belt.

25. The gripping and moving system according to claim 24, wherein said pulley arrangement comprises a plurality of return pulleys and a drive pulley rotated by said rotary electric motor.

26. The gripping and moving system according to claim 20, wherein said supporting element comprises a covering casing suitable to enclose at least said guide assembly and said driving system and provided with a longitudinal opening which extends along and at said guide assembly to allow said sensor device to scan externally.

27. The gripping and moving system according to claim 20, comprising connection brackets for fixing opposite ends of said supporting element to said work surface.

28. The gripping and moving system according to claim 20, wherein said sensor device comprises a laser scanner sensor.

29. The gripping and moving system according to claim 20, wherein said control unit is configured to control said driving system of said detection apparatus so as to position and move said sensor device along a first direction in order to scan a settled portion of the work surface in which there is at least one worked piece picked up and partially lifted by said gripping assembly.

30. The gripping and moving system according to claim 28, wherein said laser scanner sensor is an amplified photosensor.

31. The gripping and moving system according to claim 30, wherein said amplified photosensor is a polarized retro-reflective amplified photosensor with reflector.
